(19) United States
(12) Patent Application Publication
(10) Pub. No.: US 2021/0003411 A1
(43) Pub. Date: Jan. 7, 2021

(54) VEHICLE CONTROL SYSTEM, VEHICLE CONTROL METHOD, MEDIUM, AND INFORMATION PROCESSING DEVICE

(71) Applicant: HONDA MOTOR CO., LTD., Minato-ku, Tokyo (JP)

(72) Inventors: Yugo Ueda, Wako-shi (JP); Dan Umeda, Wako-shi (JP)

(21) Appl. No.: 16/977,104

(22) PCT Filed: Mar. 7, 2018
(86) PCT No.: PCT/JP2018/008749

§ 371 Date: Sep. 1, 2020

(51) Int. Cl. G01C 21/34; G01C 21/36; B60W 30/06

(52) U.S. Cl. CPC G01C 21/3423; G01C 21/3461; B60W 30/06; G01C 21/3691

(57) ABSTRACT

A vehicle control system includes: a recognizer configured to recognize a surrounding situation of a vehicle; a driving controller configured to execute automated driving in which acceleration or deceleration and steering of the vehicle are controlled according to the surrounding situation recognized by the recognizer; a first acquirer configured to acquire a first arrival time for the vehicle to arrive at a destination of the vehicle or a parking lot subsidiary to the destination from a predetermined position by the automated driving; a second acquirer configured to acquire a second arrival time for an occupant of the vehicle to arrive at the destination from the predetermined position in an alternative way in place of movement of the vehicle; an outputter configured to output information; and a proposer configured to cause the outputter to output proposal information regarding a proposal to head for the destination in the alternative way to the occupant according to comparison between the first arrival time acquired by the first acquirer and the second arrival time acquired by the second acquirer.

### TECHNICAL FIELD

The present invention relates to a vehicle control system, a vehicle control method, a program, and an information processing device.

### BACKGROUND ART

In recent years, studies of automated vehicle control (hereinafter referred to as automated driving) have been conducted. A technology for obtaining route distances and traveling times of a present route on which a vehicle is traveling and a bypass route based on received traffic information, displaying the route distances, the traveling times, and congestion distances of the present route and the bypass route, and allowing a user to select one of the present route and the bypass route has been disclosed (see Patent Document 1).

### CITATION LIST

### Patent Literature

### Patent Document 1

Japanese Unexamined Patent Application, First Publication No. 2001-349735

### SUMMARY OF INVENTION

### Technical Problem

However, the technology of the related art merely proposes selection one of a present route and a bypass route by a user, and a case in which an occupant walk toward a destination or the like is not considered. Therefore, a way in which the user can arrive at the destination or the like comfortably has not been proposed in some cases.

The present invention is devised in view of such circumstances and an objective of the present invention is to provide a vehicle control system, a vehicle control method, a program, and an information processing device capable of proposing a way for a user to arrive at a destination or the like comfortably.

### Solution to Problem

(1) A vehicle control system includes: a recognizer configured to recognize a surrounding situation of a vehicle; a driving controller configured to execute automated driving in which acceleration or deceleration and steering of the vehicle are controlled according to the surrounding situation recognized by the recognizer; a first acquirer configured to acquire a first arrival time for the vehicle to arrive at a destination of the vehicle or a parking lot subsidiary to the destination from a predetermined position by the automated driving; a second acquirer configured to acquire a second arrival time for an occupant of the vehicle to arrive at the destination from the predetermined position in an alternative way in place of movement of the vehicle; an outputter configured to output information; and a proposer configured to cause the outputter to output proposal information regarding a proposal to head for the destination in the alternative way to the occupant according to comparison between the first arrival time acquired by the first acquirer and the second arrival time acquired by the second acquirer.

(2) In the vehicle control system according to (1), the proposer may cause the outputter to output the proposal information to the occupant according to the comparison between the first arrival time and the second arrival time and cause the vehicle to arrive at the destination or the parking lot by the automated driving.

(3) In the vehicle control system according to (1) or (2), the proposer may cause the outputter to output the proposal information when the second arrival time acquired by the second acquirer is a predetermined time or more shorter than the first arrival time acquired by the first acquirer.

(4) In the vehicle control system according to (3), the proposer may acquire weather information indicating weather of an alternative route along which the occupant heads for the destination in the alternative way and change the predetermined time according to the acquired weather information.

(5) In the vehicle control system according to any one of (1) to (4), the proposer may acquire information indicating that a route along which the occupant passes to head for the destination or the parking lot is congested and cause the outputter to output the proposal information according to the comparison between the first arrival time and the second arrival time when the route is determined to be congested according to the acquired information.

(6) In the vehicle control system according to any one of (1) to (5), the proposer may acquire weather information indicating weather of an alternative route along which the occupant heads for the destination in the alternative way and determine whether the outputter outputs the proposal information according to the acquired weather information.

(7) In the vehicle control system according to (6), according to the acquired weather information, the proposer may cause the outputter to output the proposal information when the weather of the alternative route is determined to be clear or cloudy.

(8) In the vehicle control system according to any one of (1) to (7), the proposer may acquire scenery information indicating scenery of the alternative route along which the occupant heads for the destination in the alternative way and cause the outputter to not output the proposal information when the scenery is determined not to be good according to the acquired scenery information in a case in which the occupant moves in the alternative way along the alternative route.

(9) In the vehicle control system according to (8), the proposer may cause the outputter to output the proposal information when the scenery is determined to be good according to the acquired scenery information in a case in which the occupant moves in the alternative way along the alternative route.

(10) In the vehicle control system according to any one of (1) to (9), the proposer may acquire sidewalk information indicating whether there is a sidewalk along the alternative route along which the occupant heads for the destination in the alternative way and cause the outputter to output the proposal information when there is determined to be a sidewalk along the alternative route according to the acquired sidewalk information.

(11) In the vehicle control system according to any one of (1) to (10), the proposer may acquire fatigue information indicating an estimation result of fatigue of the occupant when the occupant is assumed to move to the destination or the parking lot in the alternative way and cause the outputter to output the proposal information when the acquired fatigue information is determined to be equal to or less than a set value.

(12) In the vehicle control system according to any one of (1) to (11), the proposer may cause the outputter to output the proposal information including both the first arrival time and the second arrival time.

(13) The proposer may cause the outputter to output at least one piece of information among weather information indicating weather of the alternative route along which the occupant heads for the destination in the alternative way, scenery information indicating scenery of the alternative route, sidewalk information indicating whether there is a sidewalk along the alternative route, and fatigue information indicating fatigue of the occupant when the occupant is assumed to move to the destination or the parking lot in the alternative way in addition to the second arrival time.

(14) In the vehicle control system according to any one of (1) to (13), the alternative way may be at least one way among walking, a bicycle, and a vehicle in which an operation is managed by a facility manager of the destination.

(15) A vehicle control method is configured to cause a computer to perform: executing automated driving in which acceleration or deceleration and steering of a vehicle are controlled according to a surrounding situation recognized by a recognizer recognizing a surrounding situation of the vehicle; acquiring a first arrival time for the vehicle to arrive at a destination of the vehicle or a parking lot subsidiary to the destination from a predetermined position by the automated driving; acquiring a second arrival time for an occupant of the vehicle to arrive at the destination from the predetermined position in an alternative way in place of movement of the vehicle; and causing an outputter outputting information to output proposal information regarding a proposal to head for the destination in the alternative way to the occupant according to comparison between the first arrival time acquired by the first acquirer and the second arrival time.

(16) A program is configured to cause a computer to perform: executing automated driving in which acceleration or deceleration and steering of a vehicle are controlled according to a surrounding situation recognized by a recognizer that is configured to recognize a surrounding situation of the vehicle; acquiring a first arrival time for the vehicle to arrive at a destination of the vehicle or a parking lot subsidiary to the destination from a predetermined position by the automated driving; acquiring a second arrival time for an occupant of the vehicle to arrive at the destination from the predetermined position in an alternative way in place of movement of the vehicle; and causing an outputter outputting information to output proposal information regarding a proposal to head for the destination in the alternative way to the occupant according to comparison between the first arrival time acquired by the first acquirer and the second arrival time.

(17) An information processing device includes: a first acquirer configured to acquire a first arrival time for a vehicle to arrive at a destination of the vehicle or a parking lot subsidiary to the destination from a predetermined position in automated driving executed by a driving controller that is configured to execute automated driving according to a surrounding situation recognized by a recognizer that is configured to recognize a surrounding situation of the vehicle; a second acquirer configured to acquire a second arrival time for an occupant of the vehicle to arrive at the destination from the predetermined position in an alternative way in place of movement of the vehicle; and a proposer configured to cause an outputter outputting information to output proposal information regarding a proposal to head for the destination in the alternative way to the occupant according to comparison between the first arrival time acquired by the first acquirer and the second arrival time acquired by the second acquirer.

### Advantageous Effects of Invention

According to the aspects (1) to (5) and (12) to (17), it is possible to propose a way in which a user can arrive at a destination or the like comfortably.

According to the aspects (6), (7), (10), and (11), when a burden is imposed on a user when the user heads for the destination or the like in an alternative way, proposed information is not output. Therefore, it is possible to inhibit supply of unnecessary information.

According to the aspects (8) and (9), when the user moves in the alternative way and a scenery is determined to be good, proposed information is output. It is possible to further supply useful information to the user.

### BRIEF DESCRIPTION OF DRAWINGS

FIG. 1 is a diagram showing a configuration of a vehicle system 1 in which a vehicle control device according to a first embodiment is used.

FIG. 2 is a functional configuration showing a first controller 120 and a second controller 160.

FIG. 3 is a diagram showing an example of a functional configuration of a third controller 170.

FIG. 4 is a diagram showing an example of a functional configuration of the third controller 170.

FIG. 5 is a diagram showing an example of an image IM displayed on a display by a proposer 176.

FIG. 6 is a flowchart showing an example of a flow of a process performed by the third controller 170.

FIG. 7 is a diagram showing an example of a functional configuration of an information processing system 300 including the vehicle system 1.

FIG. 8 is a diagram showing an example of a functional configuration of a third controller 170A included in a vehicle system 1A.

FIG. 9 is a diagram showing an example of content of a walking-related information 318.

FIG. 10 is a diagram showing an example of an image IM1 displayed on the display by the proposer 176.

FIG. 11 is a diagram showing an example of a hardware configuration of an automated driving control device 100 according to an embodiment.

FIG. 12 is a sequence diagram showing a flow of a process performed by an information processing system 300A.

FIG. 13 is a diagram showing an example of a hardware configuration of the automated driving control device 100 according to an embodiment.

### DESCRIPTION OF EMBODIMENTS

Hereinafter, embodiments of a vehicle control system, a vehicle control method, a program, and an information processing device according to the present invention will be described with reference to the drawings.

### First Embodiment

### [Overall Configuration]

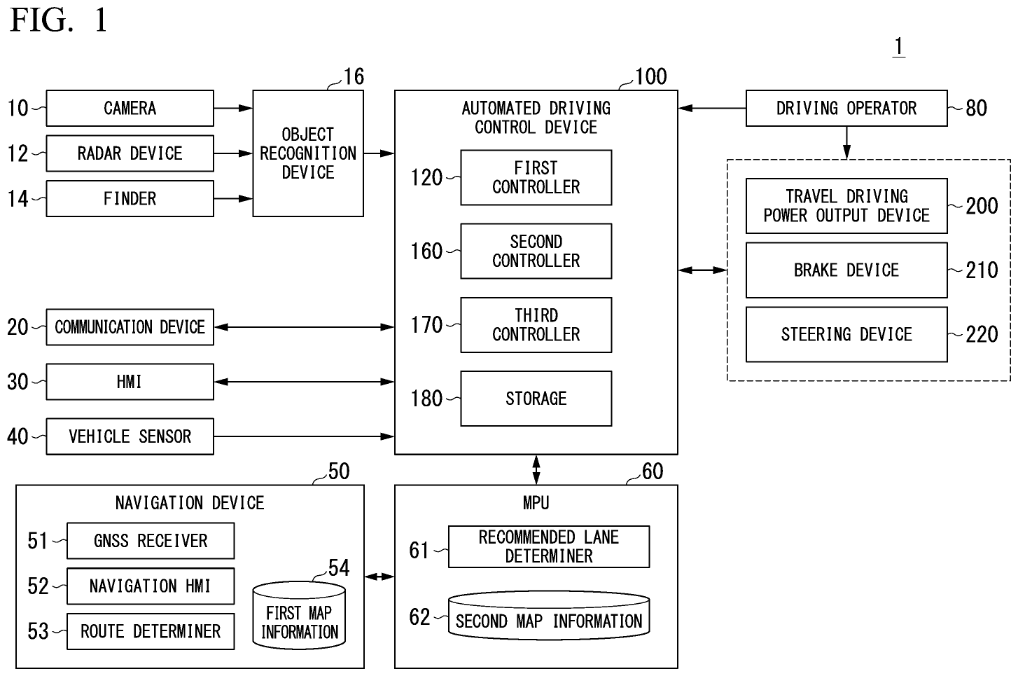

FIG. 1 is a diagram illustrating a configuration of a vehicle system 1 in which a vehicle control device according to a first embodiment is used. A vehicle in which the vehicle system 1 is mounted is (hereinafter referred to as an own vehicle M), for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely an exemplary example, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of the own vehicle M. When the camera 10 images a front side, the camera 10 is mounted on an upper portion of a front windshield, a rear surface of a rearview mirror, or the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance from and an azimuth of) of the object. One radar device 12 or a plurality of radar devices 12 are mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. One finder 14 or a plurality of finders 14 are mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change, as necessary. The object recognition device 16 may be omitted from the vehicle system 1.

The communication device 20 communicates with another vehicle around the own vehicle M or various server devices via radio base stations using, for example, a cellular network, a Wi-Fi network, Bluetooth (registered trademark), dedicated short range communication (DSRC) or the like.

The HMI 30 presents various types of information to occupants of the own vehicle M and receives input operations by the occupants. The HMI 30 includes, for example, various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory.

The GNSS receiver 51 specifies a position of the own vehicle M based on signals received from GNSS satellites. The position of the own vehicle M may be specified or complemented by an inertial navigation system (INS) using an output of the vehicle sensor 40.

The navigation HMI 52 includes a display device, a speaker, a touch panel, and a key. The navigation HMI 52 may be partially or entirely common to the above-described HMI 30.

The route determiner 53 determines, for example, a route from a position of the own vehicle M specified by the GNSS receiver 51 (or any input position) to a destination input by the occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map is output to the MPU 60.

The navigation device 50 may perform route guidance using the navigation HMI 52 based on the route on the map determined by the route determiner 53. The navigation device 50 may be realized by, for example, a function of a terminal device such as a smartphone or a tablet terminal possessed by the occupant. The navigation device 50 may transmit a present position and a destination to a navigation server via the communication device 20 to acquire the same route as the route on the map from the navigation server.

The MPU 60 functions as, for example, a recommended lane determiner 61 and retains second map information 62 in a storage device such as an HDD or a flash memory. The recommended lane determiner 61 divides a route on a map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes, information regarding boundaries of lanes, or information regarding types of lanes. The second map information 62 may include road information, traffic regulation information, address information (address and postal number), facility information, and telephone number information. The second map information 62 may be updated frequently by causing the communication device 20 to communicate with another device.

The driving operator 80 includes, for example, an accelerator pedal, a brake pedal, a shift lever, a steering wheel, a heteromorphic steering wheel, a joystick, and other operators. A sensor that detects an operation amount or presence or absence of an operation is mounted on the driving operator 80. The detection result is output to the automated driving control device 100 or some or all of the travel driving power output device 200, the brake device 210, and the steering device 220.

The automated driving control device 100 includes, for example, a first controller 120, a second controller 160, a third controller 170, and a storage 180. Each of the first controller 120, the second controller 160, and the third controller 170 is realized, for example, by causing a processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in the storage 180 of the automated driving control device 100 or may be stored in a storage medium such as a DVD or a CD-ROM which can be detachably mounted and the storage medium may be mounted on a drive device to be installed in the storage 180.

The storage 180 is realized by, for example, an HDD, a flash memory, an electrically erasable programmable read only memory (EEPROM), a read-only memory (ROM), or a random access memory (RAM). The storage unit 180 stores, for example, not only a program read and executed by a processor but also offset amount determination information 182 used to determine an offset distance to be described below.

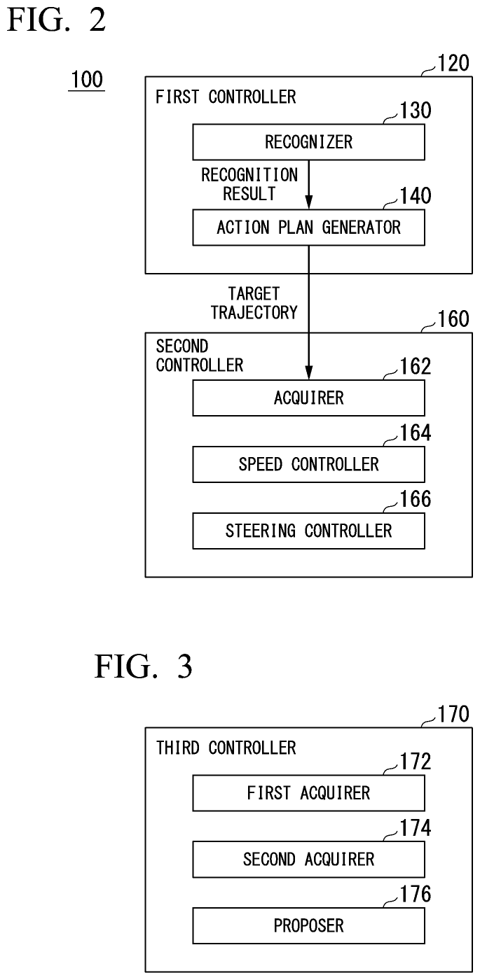

FIG. 2 is a diagram illustrating a functional configuration of the first controller 120 and the second controller 160. The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” is realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of the automated driving is guaranteed.

The recognizer 130 recognizes an object which is around the own vehicle M based on information input from the camera 10, the radar device 12, and the finder 14 via the object recognition device 16.

Examples of the object recognized by the recognizer 130 include a bicycle, an auto-bicycle, a four-wheeled vehicle, a pedestrian, a traffic sign, a road marking, a mark line, an electric pole, a guardrail, and a falling object. The recognizer 130 recognizes a state such as a position, a speed, or an acceleration of an object. For example, the position of the object is recognized as a position on the absolute coordinates in which a representative point (a center of gravity, a center of a driving shaft, or the like) of the own vehicle M is the origin (that is, a relative position to the own vehicle M) and is used for control. The position of the object may be represented as a representative point such as a center of gravity, a corner, or the like of the object or may be represented as expressed regions. A “state” of an object may include both an acceleration and jerk of the object or an “action state” (for example, whether a vehicle is changing a lane or is attempting to change the lane).

The recognizer 130 recognizes, for example, an own lane in which the own vehicle M is traveling or an adjacent lane which is adjacent to the own lane. For example, the recognizer 130 recognizes the own lane or the adjacent lane by comparing patterns of road mark lines (for example, arrangement of continuous lines and broken lines) obtained from the second map information 62 with patterns of road mark lines around the own vehicle M recognized from images captured by the camera 10.

The recognizer 130 may recognize an own lane or an adjacent lane by recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, signs, signboards, and other road events.

The recognizer 130 recognizes a relative position or posture of the own vehicle M to the own lane when the recognizer 130 recognizes the own lane. For example, the recognizer 130 may recognize a deviation from the middle of a lane of the standard point of the own vehicle M and an angle formed with a line extending along the middle of a lane in the travel direction of the own vehicle M as a relative position and posture of the own vehicle M to the own lane. Instead of this, the recognizer 130 may recognize a position or the like of the standard point of the own vehicle M with respect to any side end portion (a road mark line or a road boundary) of the own lane as the relative position of the own vehicle M to the own lane.

The recognizer 130 may further recognize kinds of lanes based on the recognized road signs or road markings, the widths of the recognized lanes, and the like. For example, the recognizer 130 recognizes an adjacent lane as a lane for only two-wheeled vehicles when the recognizer 130 recognizes a road sign representing a mark of a bicycle, recognizes a road marking representing a lane for only two-wheeled vehicles on the upper side or the lateral side of the adjacent lane, or recognizes that a road surface of the adjacent lane is painted with a predetermined color (for example, ash pink, brown, or blue) in the recognized adjacent lane.

The lane for only two-wheeled vehicles is, for example, a lane marked for only two-wheeled vehicles such as bicycles, such as a travel zone for only bicycles or a drive guidance zone for bicycles, and is in principle a lane of which a boundary with a driveway is not physically marked due to an object such as a fence or a pole on the boundary and which is marked from a lane by a mark line drawn to a road surface.

The recognizer 130 may recognize an adjacent lane as a lane only for two-wheeled vehicles, for example, when the width of the adjacent lane is within a specified range (for example, from about 1.0 [m] to 2.0 [m]). The recognizer 130 may recognize an adjacent lane as a line for only two-wheeled vehicles based on various kinds of information such as a kind of lane or the width of a lane included in the second map information 62.

For example, the action plan generator 140 determines an automated driving event on a route in which a recommended lane is determined. The event is information for regulating a traveling aspect of the own vehicle M. Examples of the event include a constant speed traveling event in which the own vehicle M is allowed to be traveling at a constant speed in the same lane, a following traveling event in which the own vehicle M is allowed to follow another vehicle closest to the own vehicle M and located within a predetermined distance (for example, within 100 [m]) in front of the own vehicle M (hereinafter referred to as a front vehicle), a lane changing event in which the own vehicle M is allowed to change its lane from the own vehicle to an adjacent lane, a branching event in which the own vehicle M is allowed to branch to a lane on a destination side at a road branching location, a joining event in which the own vehicle M is allowed to join to a main lane in a joining location, and a takeover event in which automated driving ends to switch to manual driving. For example, the “following” may be a traveling aspect in which the own vehicle M is allowed to maintain an inter-vehicle distance between the own vehicle M and the front vehicle (a relative distance) constantly or may be a traveling aspect in which the own vehicle M is allowed to travel in the middle of the own lane in addition to maintaining the inter-vehicle distance between the own vehicle M and the front vehicle constantly. Examples of the event include an overtaking event in which the own vehicle M is allowed to takes over a front vehicle in the adjacent lane by temporarily changing its lane to an adjacent lane and then returning to the original lane or by approaching the own vehicle M to a mark line marking the own lane and taking over a front vehicle in the same lane and returning to the original position (for example, the middle of the lane) without changing the own vehicle M from its lane to the adjacent lane, and an avoiding event in which the own vehicle M is allowed to perform at least one of braking and steering to avoid an obstacle in front of the own vehicle M.

For example, the action plan generator 140 may change an event determined in advance in a present section to another event in accordance with a surrounding situation recognized by the recognizer 130 at the time of traveling of the own vehicle M or may determine a new event in a present section.

The action plan generator 140 generates a future target trajectory along which the own vehicle M is allowed to travel automatedly (without depending on an operation by a driver) in a traveling aspect defined by an event so that the own vehicle M is allowed to travel in a recommended lane determined by the recommended lane determiner 61 in principle and further the own vehicle M deals with a surrounding situation at the time of traveling in the recommended lane. The target trajectory includes, for example, a position element in which a future position of the own vehicle M is determined and a speed element in which a future speed or the like of the own vehicle M is determined.

For example, the action plan generator 140 determines a plurality of locations (trajectory points) at which the own vehicle M will arrive in sequence as a position element of the target trajectory. The trajectory points are locations at which the own vehicle M will arrive for each predetermined traveling distance (for example, about several [m]). For example, the predetermined traveling distance may be calculated using a distance along a road at the time of advancing along a route

The action plan generator 140 determine a target speed and target acceleration for each a predetermined sampling time (for example, about every fractions of a second) as a speed element of the target trajectory. The trajectory points may be positions at which the own vehicle M will arrive at the sampling time for each predetermined sampling time. In this case, the target speed or the target acceleration are determined depending on the sampling time and intervals of the trajectory points. The action plan generator 140 outputs information indicating the generated target trajectory to the second controller 160.

The action plan generator 140 may change the target trajectory in accordance with a type of adjacent lane recognized by the recognizer 130. For example, when the recognizer 130 recognizes that the adjacent lane is a lane for only two-wheeled vehicles, the action plan generator 140 generates the target trajectory in which at least one or both of the speed element and the position element is changed as a new target trajectory corresponding to a present event.

The second controller 160 controls the travel driving power output device 200, the brake device 210, and the steering device 220 such that the own vehicle M passes along the target trajectory generated by the action plan generator 140 at a scheduled time.

The second controller 160 includes, for example, an acquirer 162, a speed controller 164, and a steering controller 166. A combination of the action plan generator 140 and the second controller 160 is an example of a “driving controller.”

The acquirer 162 acquires information regarding the target trajectory (trajectory points) generated by the action plan generator 140 and stores the information in a memory of the storage 180.

The speed controller 164 controls one or both of the travel driving power output device 200 and the brake device 210 based on a speed element (for example, a target speed or target acceleration) included in the target trajectory stored in a memory. Hereinafter, controlling one or both of the travel driving power output device 200 and the brake device 210 is referred to as “automated driving” in the following description.

The steering controller 166 controls the steering device 220 in accordance with a position element (for example, a curvature indicating the degree of bending of the target trajectory) included in the target trajectory stored in the memory.

Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on deviation from the target trajectory in combination.

The travel driving power output device 200 outputs travel driving power (toque) for allowing a vehicle to travel to a driving wheel. The travel driving power output device 200 includes, for example, a combination of an internal combustion engine, an electric motor, and a transmission and a power electronic control unit (ECU) controlling them. The power ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Third Controller]

FIG. 3 is a diagram showing an example of a functional configuration of the third controller 170. The third controller 170 includes, for example, a first acquirer 172, a second acquirer 174, and a proposer 176. The functional configuration is realized by allowing a processor such as a CPU to execute a program (software). Some or all of the constituent elements may be realized by hardware (a circuit unit including circuitry) such as an LSI, an ASIC, an FPGA, or a GPU or may be realized by software and hardware in cooperation. The program may be stored in advance in the storage 180 of the automated driving control device 100 or may be stored in a storage medium such as a DVD or a CD-ROM which can be detachably mounted and the storage medium may be mounted on a drive device to be installed in the storage 180.

The third controller 170 starts a process, for example, when the own vehicle M is caught in traffic congestion. The third controller 170 determines that the own vehicle M is caught in traffic congestion, for example, when vehicles are lined in front of the own vehicle M, the own vehicle M and a front vehicle are traveling in a predetermined section, and a set time or more set in advance in the predetermined section is necessary. The third controller 170 may determine that the own vehicle is caught in traffic congestion, for example, when vehicles are lined in front of the own vehicle M and a distance that the own vehicle M has traveled in a predetermined time is less than a predetermined distance or the own vehicle M is determined to be caught in traffic congestion based on information indicating a congestion section acquired by the communication device 20.

The first acquirer 172 acquires a first arrival time for the own vehicle M to arrive at a destination of the own vehicle M or a parking lot subsidiary to the destination (hereinafter referred to as a “specific parking lot”) from a predetermined position (for example, a present position) by the automated driving. For example, the first acquirer 172 estimates a required time necessary for the own vehicle M to arrive at the destination based on a distance between a present location and the destination of the own vehicle M and an average speed per hour after the congestion in which the own vehicle M is caught. The “parking lot subsidiary to the destination” is a parking lot in which users visiting a store, tourist attraction, or the like can park and is for example, a parking lot managed by (or affiliated with or the like) a manager of a destination.

For example, the required time may be estimated based on a distance to a destination, an average speed per hour, and past congestion information acquired in advance by the communication device 20. The congestion information is, for example, information including a section in which congestion has occurred in the past, a date and time, and a required time for the vehicle to pass through the congestion.

The second acquirer 174 acquires a second arrival time for an occupant of the own vehicle M to arrive at a destination from a predetermined position by walking. For example, the second acquirer 174 estimates a required time necessary for an occupant of the vehicle to arrive at the destination by walking based on a distance between the present location and the destination of the own vehicle M and a preset walking speed.

The proposer 176 causes an outputter to output proposal information regarding a proposal to head for the destination to the occupant of the own vehicle M based on comparison between the first arrival time acquired by the first acquirer 172 and the second arrival time acquired by the second acquirer 174. In this case, the proposer 176 causes the own vehicle M to park at the destination of the own vehicle M or the specific parking lot of the destination by the automated driving. The outputter is a display, a speaker, or the like included in the HMI 30. The proposal information is, for example, information for recommending that the occupant move by walking. The proposal information may be information indicating a required time in the case of movement to the destination by walking or indicating that the movement by walking is more comfortable than by vehicle or may be, for example, information such as “00 minute walk to destination,” “Walking will be more comfortable,” or “You can arrive at your destination more quickly by walking.”

When a walking route along which an occupant walks toward the destination from a position of the own vehicle M to or the like is determined to be an automobile road or a road on which walking is not allowed based on information acquired by the communication device 20 or the first map information 54, the proposer 176 may not display the proposal information on the display or may display information indicating that the occupant is not allowed to walk toward the destination or the like on the display.

[Example of Scenario in which Proposal Information is Displayed on Display]

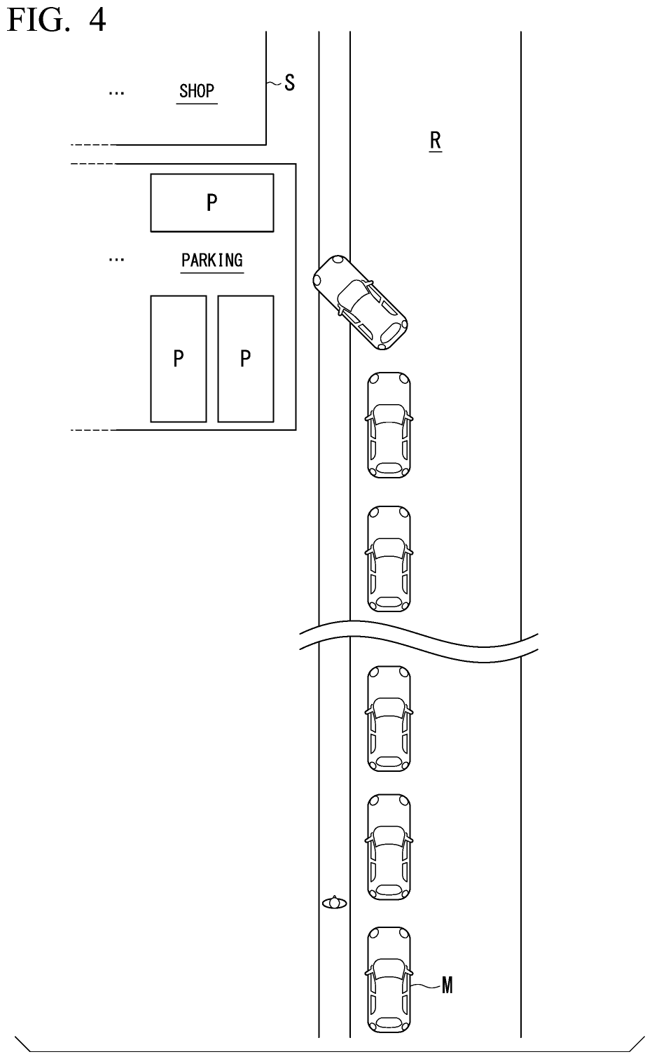

FIG. 4 is a diagram illustrating an example of a scenario in which the proposed information is displayed on the display. In the shown example, congestion occurs on a road R and the own vehicle M is caught in the congestion. The congestion occurs due to vehicles waiting to park in a specific parking lot P of a destination (for example, a store) S.

In the above scenario, for example, the third controller 170 determines that the own vehicle M is caught in traffic congestion. The first acquirer 172 acquires the first arrival time. The second acquirer 174 acquires the second arrival time.

The proposer 176 displays the above-described proposal information on the display based on comparison between the first arrival time and the second arrival time.

For example, when the second arrival time is a predetermined time (for example, 10 minutes) or more shorter than the first arrival time, the proposer 176 may propose walking toward the destination to the occupant.

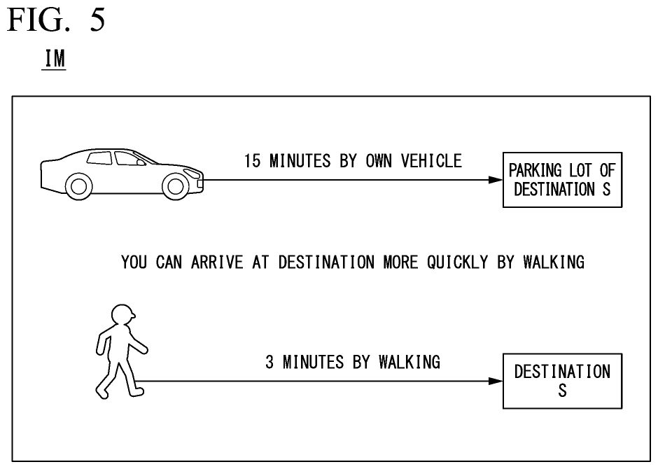

FIG. 5 is a diagram showing an example of an image IM displayed on the display by the proposer 176. For example, the image IM includes a required time estimated for the own vehicle M to arrive at the destination S, a required time estimated for the occupant of the own vehicle M to move to the destination S by walking, and information indicating a way (walking or the own vehicle M) to arrive at the destination or the like quickly. Some information (for example, the required time estimated for the own vehicle M to arrive at the destination S) in the image IM may be omitted.

### [Flowchart]

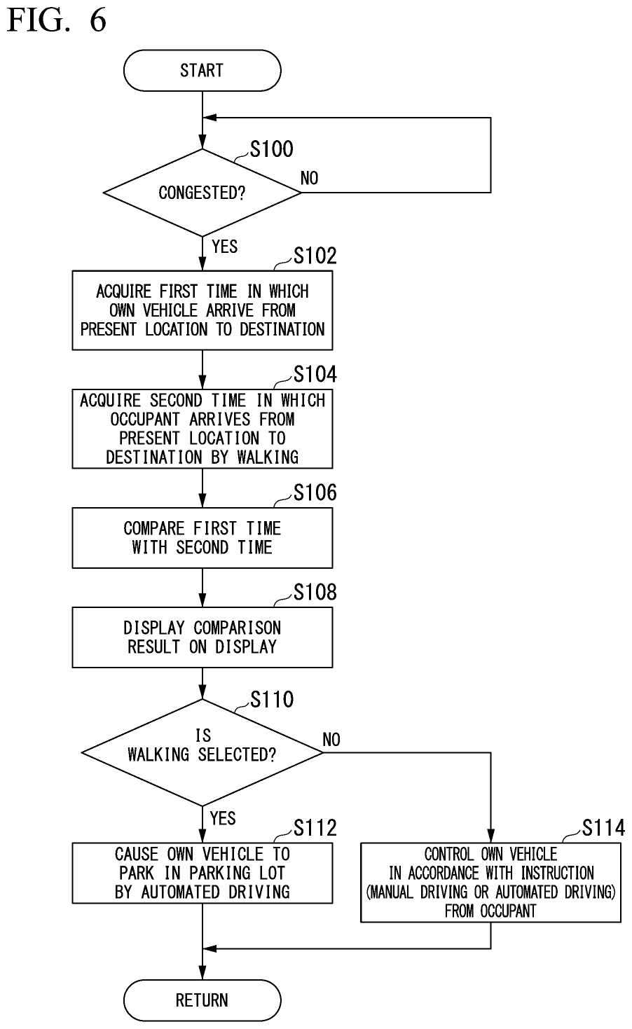

FIG. 6 is a flowchart showing an example of a flow of a process performed by the third controller 170. First, the third controller 170 determines whether the own vehicle M is caught in congestion (step S100). When the own vehicle M is caught in congestion, the first acquirer 172 acquires the first arrival time (step S102). Subsequently, the second acquirer 174 acquires the second arrival time (step S104). Subsequently, the proposer 176 compares the first arrival time with the second arrival time (step S106) and displays a comparison result on the display (step S108).

Subsequently, the proposer 176 determines whether the occupant of the vehicle selects walking (step S110). When walking is selected, the proposer 176 instructs the first controller 120 to park the own vehicle M in the parking lot by the automated driving (step S112). When the comparison result is displayed on the display and subsequently the occupant of the vehicles alights from the vehicle, the proposer 176 determines that the occupant has selected walking. Whether the occupant of the vehicle alights from the vehicle or stays in the vehicle is determined based on an image captured by an interior camera provided in the own vehicle M. Conversely, when walking is not selected, the proposer 176 instructs the first controller 120 to control the own vehicle M in accordance with an instruction (manual driving or automated driving) from the occupant (step S114). Then, the process of one routine of the flowchart ends.

Through the above-described process, the occupant of the vehicle can compare the times required to walk or drive toward the destination and select a preferred way when the vehicle is caught in congestion while moving toward the destination.

According to the above-described first embodiment, the proposer 176 can propose the way in which a user can arrive at the destination or the like comfortably by causing the outputter to output the proposal information based on comparison between the first arrival time and the second arrival time.

### Second Embodiment

A second embodiment will be described. In the first embodiment, the own vehicle M acquires the first arrival time. As described in the second embodiment, however, the own vehicle M acquires the first arrival time from an information supply device. Hereinafter, differences from the first embodiment will be mainly described.

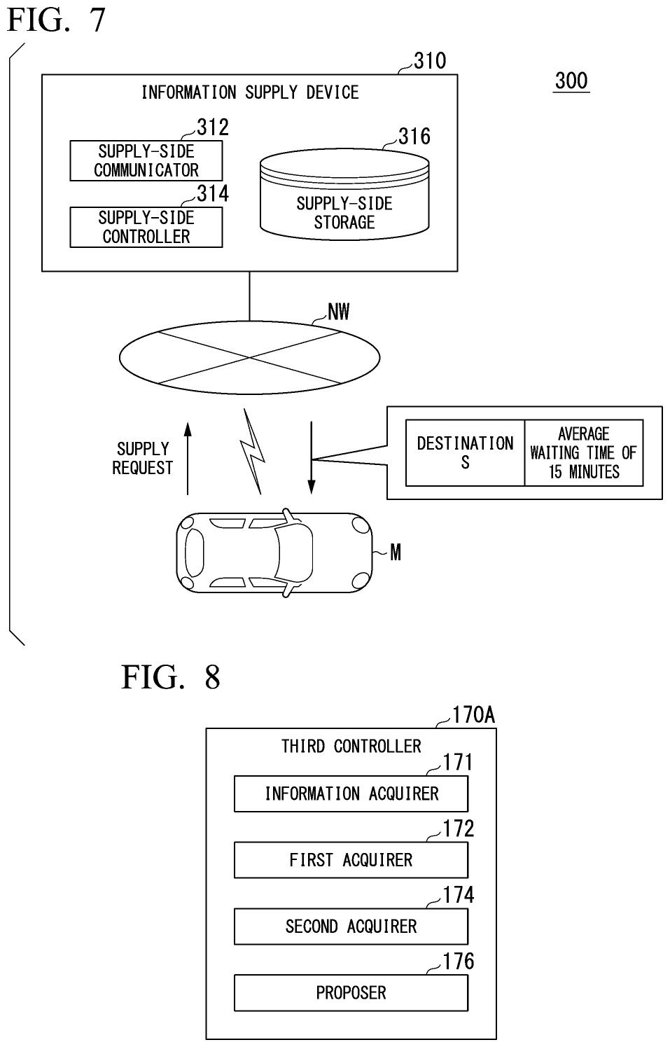

FIG. 7 is a diagram showing an example of a functional configuration of an information processing system 300 including the vehicle system 1. The information processing system 300 includes the own vehicle M and an information supply device 310. The own vehicle M and the information supply device 310 communicate with each other via a network NW. The network NW includes, for example, a wide area network (WAN), a local area network (LAN), the Internet, a dedicated line, a wireless base station, and a provider.

The information supply device 310 includes a supply-side communicator 312, a supply-side controller 314, and a supply-side storage 316. The supply-side communicator 312 transmits a processing result of the supply-side controller 314 to the own vehicle M. Based on information stored in the supply-side storage 316, the supply-side controller 314 derives a required time for the own vehicle M to be able to park in the parking lot. The supply-side controller 314 derives the required time in response to a request for supplying information from the own vehicle M and responds to the own vehicle M with information indicating the derived required time. The supply-side storage 316 stores congestion information of a road managed by the information supply device 310, congestion information of the parking lot, a time in which a vehicle parked in the parking lot uses the parking lot, and the like. The information is, for example, information acquired from another device via a network by the information supply device 310 or information derived from information acquired in the past. The other device is, for example, a manager server managing the parking lot or a manager server managing traffic states of roads.

The first acquirer 172 of the third controller 170 transmits a supply request to the information supply device 310 in order to request the information supply device 310 to supply an arrival time for the own vehicle M to arrive at a destination or a parking lot subsidiary to the destination from the position of the own vehicle M. Then, the first acquirer 172 acquires a required time to the destination which is a response to the supply request. Thus, the third controller 170 can derive the first arrival time with more precision.

The second acquirer 174 of the third controller 170 may acquire information for deriving the second arrival time from the information supply device 310 in addition to (or instead of) the first arrival time. The own vehicle M may have the same functional configuration as the above-described information supply device 310. That is, the third controller 170 may acquire information from another server device supplying congestion information in the own vehicle M and derive a required time for the own vehicle M to arrive at the parking lot based on the acquired information.

According to the above-described second embodiment, the third controller 170 can derive the first arrival time with more precision to acquire information for deriving the first arrival time from the information supply device 310.

### Third Embodiment

A third embodiment will be described. As described above, in the second embodiment, the own vehicle M acquires the first arrival time from the information supply device 310. In the third embodiment, however, information other than the first arrival time is also acquired from the information supply device 310. Hereinafter, differences from the second embodiment will be mainly described.

FIG. 8 is a diagram showing an example of a functional configuration of a third controller 170A included in the vehicle system 1A. The third controller 170A further includes an information acquirer 171 in addition to the functional configuration of the third controller 170 in the first embodiment. The information acquirer 171 requests the information supply device 310 to transmit walking-related information 318 to be described below.

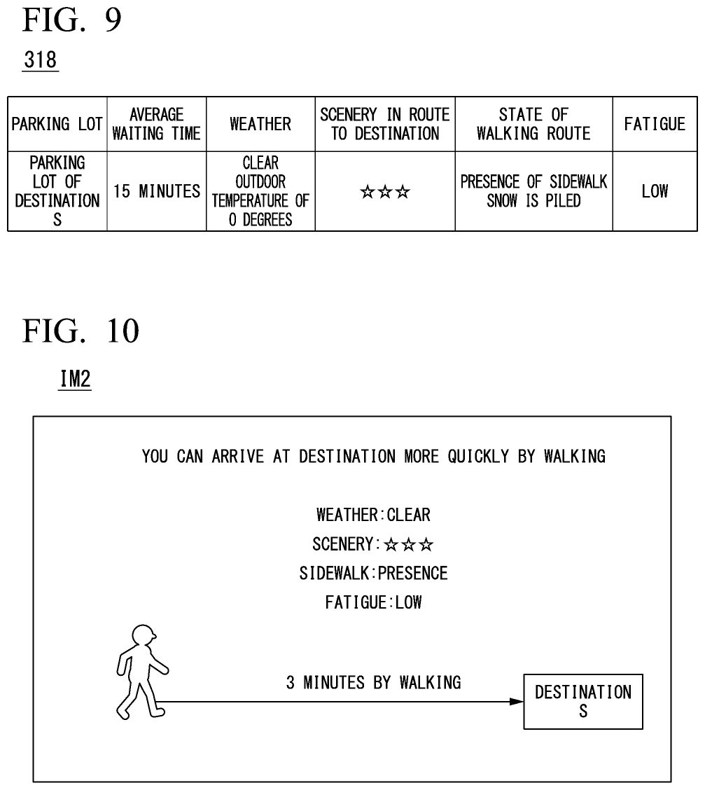

For example, the information supply device 310 transmits the walking-related information 318 in response to a request of the information acquirer 171 of the own vehicle M to the own vehicle M. FIG. 9 is a diagram showing an example of content of the walking-related information 318. The walking-related information 318 is, for example, a parking lot in which the own vehicle M is scheduled to park, a required time estimated to be necessary until parking in the parking lot, weather information (clear, rain, outdoor temperature, or the like) near a walking route along which the occupant walks toward the destination from the position of the own vehicle M, scenery information (an index indicating good points of scenery) of the walking route, state information of a walking route, and fatigue information.

State information of the walking route is, for example, information or an index indicating easiness of walking on the walking route. The information indicating the easiness of walking is, for example, information indicating presence of absence of a sidewalk or likelihood of slipping on a walking route (or a sidewalk) (the degree of freezing on the sidewalk) or indicating that snow has accumulated or there is ponding. For example, when there is a sidewalk, when slipping is not likely on a walking route (or a sidewalk), when snow has not accumulated, or when there is no ponding, information or the index indicating the easiness of walking on the walking route is set to be higher than when there is no sidewalk, when slipping is likely on the walking route (or a sidewalk), when snow has accumulated, and when there is a ponding.

The fatigue information is, for example, fatigue estimated when an occupant moves by walking along a walking route toward a destination. For example, when the walking route includes a route of a rising gradient, fatigue is set to be higher than for a walking route which does not include a rising gradient. For example, when the distance of the walking route (the distance to the destination) is equal to or greater than a predetermined distance, fatigue is set to be higher than when the distance is less than the predetermined distance.

The proposer 176 of the own vehicle M displays the proposal information on the display with reference to the walking-related information 318 acquired by the information acquirer 171. For example, the proposer 176 displays the proposal information on the display when a route along which the occupant walks toward the destination is determined to be in clear or cloudy weather. This is because when it rains or snows, the occupant of the vehicle is predicted to not like walking.

For example, when the outside temperature of the walking route is within a range of a predetermined temperature (a temperature at which the occupant does not feel uncomfortable) when the occupant moves by walking, the proposer 176 displays the proposal information on the display.

For example, when the second arrival time is a predetermined time or more shorter than the first arrival time, the proposer 176 may display the proposal information on the display. In this case, the predetermined time is changed based on weather information. For example, a predetermined time in clear or cloudy weather is set to be shorter than a predetermined time in rain or snow. The occupant prefers not to move by walking in the case of rain or snow. Therefore, the proposer 176 displays the proposal information on the display when the second arrival time is shorter than the first arrival time to some extent (than when it does not rain or snow).

When scenery is determined to be good along the walking route, the proposer 176 may display the proposal information on the display. When scenery is good, an index indicating that the scenery is good is equal to or greater than a predetermined value. When scenery is good, an element such as a good atmosphere (for example, many people laugh) may be received. In this case, for example, the proposer 176 may determine that the scenery is good along a walking route based on a recognition result of the recognizer 130 when many people around the walking route laugh or many people are taking photos. In this case, the proposer 176 may raise an index indicating pre-decided favorability of scenery. The proposer 176 may display the proposal information on the display when the index indicating the favorability of the scenery is equal to or greater than a predetermined value and the second arrival time is shorter than the first arrival time within a range of a set time. The occupant who likes to enjoy the scenery on the way to the destination can acquire useful information.

When it is determined based on the state information of the walking route that there is a sidewalk along the walking route, the proposer 176 may display the proposal information on the display. This is because the occupant can arrive at the destination comfortably, safely, and quickly when there is the sidewalk along the walking route.

When it is determined based on the state information of the walking route that the easiness of walking on a sidewalk (or along the walking route) along the walking route is equal to or greater than a predetermined value, the proposer 176 may display the proposal information on the display. This is because the occupant can arrive at the destination comfortably, safely, and quickly when the walking route is a walking route along which the occupant can easily walk.

When the fatigue information is determined to be equal to or less than a set value, the proposer 176 may display the proposal information on the display. This is because when the fatigue is equal to or less than the set value, convenience for the user is improved even though a time of arrival at the destination is longer than by walking.

The proposer 176 may grant a score to each item of an average waiting time, the weather information, the scenery information, the state information of the walking route, and the fatigue information included in the foregoing walking-related information 318 and determine whether to display the proposal information on the display based on a result obtained by statistically processing the score granted to each item. For example, when the result obtained by statistically processing the score is equal to or greater than a predetermined value, the proposer 176 displays the proposal information on the display. When a weight of a predetermined item may be increased among the items included in the walking-related information 318 or there is an item of which the score is equal to or less than a threshold among predetermined items, the proposing may not be performed. Thus, when it rains or snow has accumulated on a sidewalk or it is not appropriate to move by walking as in a case in which the occupant moves on a rising gradient by walking, the proposing is not performed.

FIG. 10 is a diagram showing an example of an image IM1 displayed on the display by the proposer 176. For example, the image IM1 includes a required time estimated to be necessary for the occupant of the own vehicle M to move to the destination S by walking and information indicating each item of the walking-related information 318. The information is, for example, weather of a route toward the destination, presence or absence of a sidewalk along the route toward the destination, a state of the sidewalk, scenery from the walking route, and fatigue in a case in which the occupant heads for the destination. An actual image of the scenery from the walking route, a graphic image, or the like may be displayed on the display. The proposer 176 may display a required time for the own vehicle M to arrive at the destination or the specific parking lot in addition to the above-described information.

When the occupant performs a predetermined operation on an operation portion of the HMI 30, the proposer 176 may display the image IM1 or the required time on the display in a case in which the own vehicle M heads for the destination in response to the operation. Thus, the occupant can determine whether to head for the destination aboard the own vehicle M or head for the destination.

The information (for example, the weather information, the scenery information, and the state information of the walking route) included in the walking-related information 318 may be derived by the third controller 170A. For example, the third controller 170A derives the information included in the walking-related information 318 based on a recognition result (for example, a result of an image recognition process) of the recognizer 130.

According to the above-described third embodiment, the proposer 176 can present a user with comfort in a case in which the occupant walks along the walking route by determining whether to display the proposal information on the display based on the information included in the walking-related information 318.

### Fourth Embodiment

A fourth embodiment will be described. As described in the second and third embodiments, the third controller 170 of the own vehicle M has caused the outputter to output the proposal information. In the fourth embodiment, however, the proposing device 410 causes an outputter of a terminal device 500 to output the proposal information. Hereinafter, differences from the first embodiment will be mainly described.

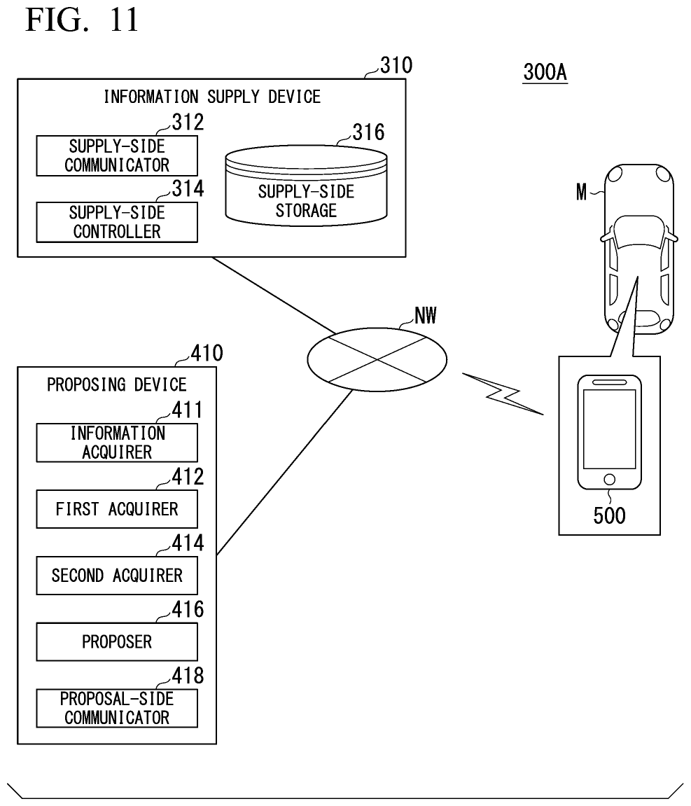

FIG. 11 is a diagram showing an example of a functional configuration of an information processing system 300A according to the fourth embodiment. The information processing system 300A includes, for example, the own vehicle M, the information supply device 310, a proposing device 410, and a terminal device 500. In the information processing system 300A, the own vehicle M or the information supply device 310 may be omitted.

The proposing device 410 includes, for example, an information acquirer 411, a first acquirer 412, a second acquirer 414, a proposer 416, and a proposal-side communicator 418. The information acquirer 411, the first acquirer 412, the second acquirer 414, and the proposer 416 respectively have the same functions as those of the information acquirer 171, the first acquirer 172, the second acquirer 174, and the proposer 176 in the second embodiment.

That is, the proposing device 410 has the following functions. The information acquirer 411 requests the information supply device 310 to transmit the walking-related information 318 and acquires the walking-related information 318. The information acquirer 411 requests the information supply device 310 to supply the walking-related information 318. The first acquirer 412 derives the first arrival time. The second acquirer 414 derives the second arrival time. The proposer 416 causes an outputter of the terminal device 500 to output the proposal information for proposing to walk toward the destination by walking to the occupant based on comparison between the first arrival time derived by the first acquirer 412 and the second arrival time derived by the second acquirer 414. The proposal-side communicator 418 communicates with another device or the like via the network NW.

The terminal device 500 is, for example, a smartphone or a tablet terminal. The terminal device 500 includes, for example, a position specifier and an outputter. The position specifier specifies a position of an own device based on signals received from GNSS satellites. In the following description, the terminal device 500 is assumed to be carried by the occupant of the own vehicle M. The outputter is, for example, a touch panel in which a display and an operation portion are integrated. The display and the operation portion may be separately provided.

### [Content of Process]

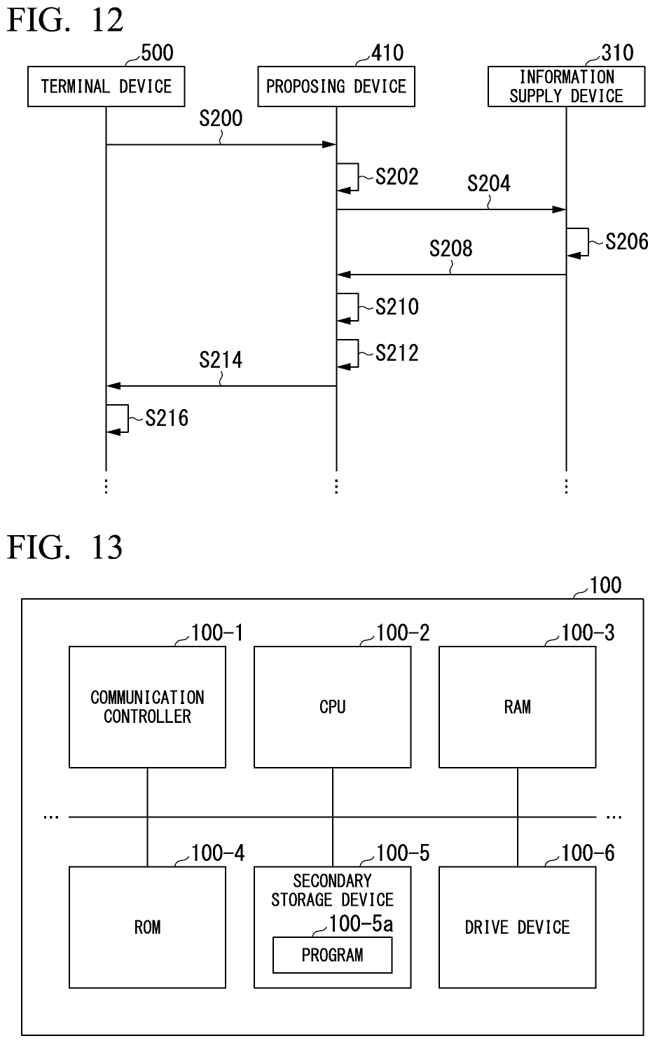

FIG. 12 is a sequence diagram showing a flow of a process performed by the information processing system 300A. When a predetermined operation of an occupant is received, the terminal device 500 transmits, to the proposing device 410, information in which identification information of the own device, a destination of the occupant, identification information (or positional information) of a specific parking lot in which the vehicle is scheduled to park, positional information of the own device, and a request for supplying the proposal information are associated with each other (step S200). The destination of the occupant and the identification information of the parking lot in which the vehicle is scheduled to park is information input by the occupant operating the terminal device 500. For example, when the own vehicle M is allowed to park in a parking lot of a tourist attraction or a store and is caught in congestion occurring due to waiting for a vacant space of the parking lot, the occupant requests supply of the proposal information.

Subsequently, when correspondence information is received, the second acquirer 414 of the proposing device 410 acquires the walking route and the second arrival time based on the positional information of the terminal device 500, the destination of the occupant, and map information (step S202). The map information is stored in a storage device of the proposing device 410.

Subsequently, the information acquirer 411 of the proposing device 410 requests the information supply device 310 to transmit the walking-related information 318 corresponding to the correspondence information (step S204). The corresponding walking-related information 318 is, for example, congestion information near a road assumed to be used when the occupant heads for the specific parking lot included in the correspondence information from the position of the own device (or the route of the own vehicle M acquired from the terminal device 500), weather information near the walking route, the scenery information of the walking route, the state information of the walking route, and the fatigue information.

Subsequently, the information supply device 310 extracts the walking-related information 318 corresponding to the above-described correspondence information from the supply-side storage 316 in response to the request from the information acquirer 411 (step s206) and transmits the extracted walking-related information 318 to the proposing device 410 (step S208). Then, the information acquirer 411 acquires the walking-related information 318 transmitted by the information supply device 310.

Subsequently, the first acquirer 412 of the proposing device 410 derives the first arrival time based on the walking-related information 318 (for example, congestion information of the road assumed to be used when the occupant heads for the destination) transmitted in step S208 (step S210). Then, the proposer 416 generates the proposal information including the first arrival time derived in step S210 and the second arrival time derived in step S202 (step S212) and transmits the generated proposal information to the terminal device 500 (step S214). Subsequently, the terminal device 500 displays the proposal information transmitted in step S214 on the display (step S216).

As described above, the proposing device 410 acquires the first arrival time and the second arrival time based on the information acquired from the information supply device 310 and displays the proposal information generated based on the acquired information on the display of the terminal device 500. Therefore, it is possible to propose a way for the user to arrive at the destination or the like comfortably.

In the above-described example, the information supply device 310 and the proposing device 410 are separate devices in the above description, but may be integrated. In the third embodiment, the third controller 170 of the own vehicle M may be omitted.

The proposing device 410 may communicate with the own vehicle M and vehicles near the position of the own vehicle M and acquire information regarding a walking route or a route heading for toward the destination or the like (for example, an image obtained by imaging the surroundings). Then, the proposing device 410 may acquire the first arrival time, the second arrival time, or the walking-related information 318 based on the acquired information.

According to the above-described first to fourth embodiments, the third controller 170 has acquired the second arrival time in which the occupant can arrive from a predetermined position to the destination by walking, but may acquire the second arrival time in which the occupant arrives from the predetermined position to the destination in an alternative way other than walking substituting for the movement by vehicle instead of (or in addition to) walking. In this case, the proposer 176 causes the outputter to output the proposal information for proposing to head for the destination in the alternative way to the occupant based on the comparison between the first arrival time and the second arrival time. The alternative way is, for example, a bicycle or a shuttle bus, a train, or a streetcar traveling in a dedicated road and heading for the destination in addition to walking. When there are a plurality of alternative ways, the proposer 176 may include, in the proposal information, a required time or an arrival time when the occupant heads for the destination in each alternative way, an index indicating convenience, scenery of a route when the occupant heads for the destination in the alternative way, fatigue (for example, information regarding presence or the like of ascending or descending stairs), weather information, and information of the state of a route along which the occupant passes in the alternative way.

According to the above-described first to fourth embodiments, the vehicle control system includes: the recognizer 130 configured to recognize a surrounding situation of the own vehicle M; the driving controller (120, 160) configured to execute automated driving in which acceleration or deceleration and steering of the own vehicle M are controlled based on the surrounding situation recognized by the recognizer 130; the first acquirer 172 configured to acquire the first arrival time in which the own vehicle M arrives from a predetermined position to a destination of the vehicle or a parking lot subsidiary to the destination by the automated driving; the second acquirer 174 configured to acquire the second arrival time in which an occupant of the vehicle arrives from the predetermined position to the destination in an alternative way; the HMI 30 configured to output information; and the proposer 176 configured to cause the HMI 30 to output proposal information regarding a proposal to head for the destination in the alternative way to the occupant based on comparison between the first arrival time acquired by the first acquirer 172 and the second arrival time acquired by the second acquirer 174. It is possible to propose a way in which the user can arrive at the destination or the like comfortably.

### [Hardware Configuration]

FIG. 13 is a diagram showing an example of a hardware configuration of the automated driving control device 100 according to an embodiment. As shown, the automated driving control device 100 is configured such that a communication controller 100-1, a CPU 100-2, a RAM 100-3 used as a working memory, a ROM 100-4 storing a boot program or the like, a secondary storage device 100-5 such as a flash memory or an HDD, and a drive device 100-6 are connected to each other via an internal bus or a dedicated communication line. The communication controller 100-1 communicates with other constituent elements of the automated driving control device 100. The storage device 100-5 stores a program 100-5a that is executed by the CPU 100-2. The program is loaded to the RAM 100-3 such as a direct memory access (DMA) controller (not shown) and is executed by the CPU 100-2. Thus, one or both of the first controller 120 and the second controller 160 are realized.

The above-described embodiments can be expressed as follows:

a vehicle control device including:

a storage device storing a program; and

a processor,

wherein the processor executing the program to perform:

recognizing a surrounding situation of a vehicle;

executing automated driving in which acceleration or deceleration and steering of the vehicle are controlled according to the recognized surrounding situation;

acquiring a first arrival time for the vehicle to arrive at a destination of the vehicle or a parking lot subsidiary to the destination from a predetermined position by the automated driving;

acquiring a second arrival time in which an occupant of the vehicle arrives from the predetermined position to the destination in an alternative way; and

causing the vehicle to arrive at the destination or the parking lot by the automated driving according to comparison between the acquired first arrival time and the acquired second arrival time and causing the outputter to output proposal information regarding a proposal to head for the destination in the alternative way to the occupant.

The embodiments for carrying out the present invention have been described above, but the present invention is not limited to the embodiments. Various modifications and substitutions can be made within the scope of the present invention without departing from the gist of the present invention.

### REFERENCE SIGNS LIST

1 Vehicle system
10 Camera
12 Radar device
14 Finder
16 Object recognition device
20 Communication device
30 HMI
100 Automated driving control device
120 First controller
130 Recognizer
140 Action plan generator
142 Event determiner
144 Target trajectory generator
160 Second controller
162 Acquirer
164 Speed controller
166 Steering controller
170, 170A Third controller
171, 411 Information acquirer
172, 412 First acquirer
174, 414 Second acquirer
176, 416 Proposer
200 Travel driving power output device
210 Brake device
220 Steering device
300, 300A Information processing system
310 Information supply device
318 Walking-related information
400 Proposing device
418 Proposal-side communicator

1.-17. (canceled)

18. A vehicle control system comprising:
a recognizer configured to recognize a surrounding situation of a vehicle;
a driving controller configured to execute automated driving in which acceleration or deceleration and steering of the vehicle are controlled according to the surrounding situation recognized by the recognizer;
a first acquirer configured to acquire a first arrival time for the vehicle to arrive at a destination of the vehicle or a parking lot subsidiary to the destination from a predetermined position by the automated driving;
a second acquirer configured to acquire a second arrival time for an occupant of the vehicle to arrive at the destination from the predetermined position in an alternative way in place of movement of the vehicle;
an outputter configured to output information; and
a proposer configured to cause the outputter to output proposal information regarding a proposal to head for the destination in the alternative way to the occupant according to comparison between the first arrival time acquired by the first acquirer and the second arrival time acquired by the second acquirer,
wherein the proposer is configured to cause the outputter to output the proposal information to the occupant according to the comparison between the first arrival time and the second arrival time and cause the vehicle to arrive at the destination or the parking lot by the automated driving after the occupant heads for the destination by walking when the occupant heads for the destination by walking according to the proposal information.

19. The vehicle control system according to claim 18, wherein the proposer is configured to cause the outputter to output the proposal information when the second arrival time acquired by the second acquirer is a predetermined time or more shorter than the first arrival time acquired by the first acquirer.

20. The vehicle control system according to claim 19, wherein the proposer is configured to acquire weather information indicating weather of an alternative route along which the occupant heads for the destination in the alternative way and changes the predetermined time according to the acquired weather information.

21. The vehicle control system according to claim 18, wherein the proposer is configured to acquire information indicating that a route along which the vehicle passes to head for the destination or the parking lot is congested and cause the outputter to output the proposal information according to the comparison between the first arrival time and the second arrival time when the route is determined to be congested according to the acquired information.

22. The vehicle control system according to claim 18, wherein the proposer is configured to acquire weather information indicating weather of an alternative route along which the occupant heads for the destination in the alternative way and determine whether the outputter outputs the proposal information according to the acquired weather information.

23. The vehicle control system according to claim 22, wherein, according to the acquired weather information, the proposer is configured to cause the outputter to output the proposal information when the weather of the alternative route is determined to be clear or cloudy.

24. The vehicle control system according to claim 18, wherein the proposer is configured to acquire scenery information indicating scenery of the alternative route along which the occupant heads for the destination in the alternative way and cause the outputter to not output the proposal information when the scenery is determined not to be fine according to the acquired scenery information in a case in which the occupant moves in the alternative way along the alternative route.

25. The vehicle control system according to claim 24, wherein the proposer is configured to cause the outputter to output the proposal information when the scenery is determined to be fine according to the acquired scenery information in a case in which the occupant moves in the alternative way along the alternative route.

26. The vehicle control system according to claim 18, wherein the proposer is configured to acquire sidewalk information indicating whether there is a sidewalk along the alternative route along which the occupant heads for the destination in the alternative way and cause the outputter to output the proposal information when there is determined to be a sidewalk along the alternative route according to the acquired sidewalk information.

27. The vehicle control system according to claim 18, wherein the proposer is configured to acquire fatigue information indicating an estimation result of fatigue of the occupant when the occupant is assumed to move to the destination or the parking lot in the alternative way and cause the outputter to output the proposal information when the acquired fatigue information is determined to be equal to or less than a set value.

28. The vehicle control system according to claim 18, wherein the proposer is configured to cause the outputter to output the proposal information including both the first arrival time and the second arrival time.

29. The vehicle control system according to claim 18, wherein the proposer is configured to cause the outputter to output at least one of weather information indicating weather of the alternative route along which the occupant heads for the destination in the alternative way, scenery information indicating scenery of the alternative route, sidewalk information indicating whether there is a sidewalk along the alternative route, and fatigue information indicating fatigue of the occupant when the occupant is assumed to move to the destination or the parking lot in the alternative way in addition to the second arrival time.

30. The vehicle control system according to claim 18, wherein the alternative way is at least one way among walking, a bicycle, and a vehicle managed by a facility manager of the destination.

31. A vehicle control method causing a computer to perform:
executing automated driving in which acceleration or deceleration and steering of a vehicle are controlled according to a surrounding situation recognized by a recognizer recognizing a surrounding situation of the vehicle;
acquiring a first arrival time for the vehicle to arrive at a destination of the vehicle or a parking lot subsidiary to the destination from a predetermined position by the automated driving;
acquiring a second arrival time for an occupant of the vehicle to arrive at the destination from the predetermined position in an alternative way in place of movement of the vehicle; and
causing an outputter outputting information to output proposal information regarding a proposal to head for the destination in the alternative way to the occupant according to comparison between the first arrival time acquired by the first acquirer and the second arrival time,
wherein the vehicle is caused to arrive at the destination or the parking lot by the automated driving after the occupant heads for the destination by walking when the occupant heads for the destination by walking according to the proposal information.

32. A non-transitory computer-readable storage medium that is configured to store a computer program to be executed by a computer to perform at least:
execute automated driving in which acceleration or deceleration and steering of a vehicle are controlled according to a surrounding situation recognized by a recognizer that is configured to recognize a surrounding situation of the vehicle;
acquire a first arrival time for the vehicle to arrive at a destination of the vehicle or a parking lot subsidiary to the destination from a predetermined position by the automated driving;
acquire a second arrival time for an occupant of the vehicle to arrive at the destination from the predetermined position in an alternative way in place of movement of the vehicle; and
cause an outputter outputting information to output proposal information regarding a proposal to head for the destination in the alternative way to the occupant according to comparison between the first arrival time acquired by the first acquirer and the second arrival time,
wherein the vehicle is caused to arrive at the destination or the parking lot by the automated driving after the occupant heads for the destination by walking when the occupant heads for the destination on the walking according to the proposal information.

33. An information processing device comprising:
a first acquirer configured to acquire a first arrival time for a vehicle to arrive at a destination of the vehicle or a parking lot subsidiary to the destination from a predetermined position in automated driving executed by a driving controller that executes automated driving according to a surrounding situation recognized by a recognizer that is configured to recognize a surrounding situation of the vehicle;
a second acquirer configured to acquire a second arrival time for an occupant of the vehicle to arrive at the destination from the predetermined position in an alternative way in place of movement of the vehicle; and
a proposer configured to cause an outputter outputting information to output proposal information regarding a proposal to head for the destination in the alternative way to the occupant according to comparison between the first arrival time acquired by the first acquirer and the second arrival time acquired by the second acquirer,
wherein the proposer is configured to cause the outputter to output the proposal information when the second arrival time acquired by the second acquirer is a predetermined time or more shorter than the first arrival time acquired by the first acquirer, and
wherein the proposer is configured to acquire weather information indicating weather of an alternative route along which the occupant heads for the destination in the alternative way and changes the predetermined time according to the acquired weather information.

34. An information processing device comprising:
a first acquirer configured to acquire a first arrival time for a vehicle to arrive at a destination of the vehicle or a parking lot subsidiary to the destination from a predetermined position in automated driving executed by a driving controller that executes automated driving according to a surrounding situation recognized by a recognizer that is configured to recognize a surrounding situation of the vehicle;
a second acquirer configured to acquire a second arrival time for an occupant of the vehicle to arrive at the destination from the predetermined position in an alternative way in place of movement of the vehicle; and
a proposer configured to cause an outputter outputting information to output proposal information regarding a proposal to head for the destination in the alternative way to the occupant according to comparison between the first arrival time acquired by the first acquirer and the second arrival time acquired by the second acquirer,
wherein the proposer is configured to acquire sidewalk information indicating whether there is a sidewalk along the alternative route along which the occupant heads for the destination in the alternative way and cause the outputter to output the proposal information when there is determined to be a sidewalk along the alternative route according to the acquired sidewalk information.
